(19) United States
(12) Patent Application Publication
(10) Pub. No.: US 2026/0255225 A1
(43) Pub. Date: Aug. 27, 2026

(54) LINK RECONFIGURATION REQUEST AND RESPONSE ENHANCEMENTS FOR SEAMLESS ROAMING

(71) Applicant: Cisco Technology, Inc., San Jose, CA (US)

(72) Inventors: Binita GUPTA, San Diego, CA (US); Brian D. HART, Sunnyvale, CA (US)

(21) Appl. No.: 19/550,199

(22) Filed: Feb. 25, 2026

Related U.S. Application Data
(60) Provisional application No. 63/764,227, filed on Feb. 27, 2025.
(60) Provisional application No. 63/945,579, filed on Dec. 19, 2025.
(60) Provisional application No. 63/951,344, filed on Dec. 30, 2025.

(51) Int. Cl. H04W 36/00

(52) U.S. Cl. CPC H04W 36/0016; H04W 36/0033

(57) ABSTRACT

Described herein is a network that allows a non-AP MLD to delete (or cancel) a previous roaming preparation with a target AP MLD. A first AP MLD performs an operation that includes receiving, from a non-AP MLD, a first link reconfiguration request indicating that the non-AP MLD is requesting to perform roaming preparation for a second AP MLD, instructing the second AP MLD to perform roaming preparation for the non-AP MLD based on the first link reconfiguration request, transmitting, to the non-AP MLD, a first link reconfiguration response indicating that the second AP MLD is prepared for roaming, after transmitting the first link reconfiguration response, receiving, from the non-AP MLD, a second link reconfiguration request requesting deletion of the roaming preparation at the second AP MLD, and instructing the second AP MLD to delete the roaming preparation based on the second link reconfiguration request.

### CROSS-REFERENCE TO RELATED APPLICATIONS

This application claims benefit of co-pending U.S. provisional patent application Ser. No. 63/764,227 filed Feb. 27, 2025, co-pending U.S. provisional patent application Ser. No. 63/945,579 filed Dec. 19, 2025, and co-pending U.S. provisional patent application Ser. No. 63/951,344 filed Dec. 30, 2025. The aforementioned related patent applications are herein incorporated by reference in their entirety.

### TECHNICAL FIELD

Embodiments presented in this disclosure generally relate to wireless communication. More specifically, embodiments disclosed herein relate to link reconfiguration request and response enhancements for seamless roaming.

### BACKGROUND

Link reconfiguration is a procedure that allows a non-access point multi-link device (non-AP MLD) (which may also be referred to as a device or client) to reconfigure its set of links (e.g., add a link, delete a link, etc.) with an access point multi-link device (AP MLD) (which may also be referred to as an access point) without reassociating with the AP MLD (e.g., by exchanging link reconfiguration requests and responses with the access point). Seamless roaming is a procedure that allows the non-AP MLD to quickly roam between AP MLDs in a seamless mobility domain (SMD). Generally, seamless roaming involves a target AP MLD adding links for a non-AP MLD that will soon roam to the target AP MLD.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates the system of FIG. 1A.

FIG. 1C illustrates an example network controller, access point, or device in the system of FIG. 1A.

FIG. 2A illustrates an example operation performed by the system of FIG. 1A.

FIG. 2B illustrates an example operation performed by the system of FIG. 1A.

FIG. 2C illustrates an example operation performed by the system of FIG. 1A.

FIG. 3A illustrates an example message in the system of FIG. 1A.

FIG. 3B illustrates an example table used in the system of FIG. 1A.

FIG. 3C illustrates an example message in the system of FIG. 1A.

FIG. 3D illustrates an example message in the system of FIG. 1A.

FIG. 3E illustrates an example message in the system of FIG. 1A.

FIG. 4 illustrates an example operation performed by the system of FIG. 1A.

FIG. 5 illustrates an example message in the system of FIG. 1A.

FIG. 6 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

The present disclosure describes a network that allows a non-AP MLD to delete (or cancel) a previous roaming preparation with a target AP MLD. According to an embodiment, a first AP MLD includes one or more memories and one or more processors communicatively coupled to the one or more memories. The one or more processors, individually or collectively, perform an operation that includes receiving, from a non-AP MLD, a first link reconfiguration request indicating that the non-AP MLD is requesting to perform roaming preparation for a second AP MLD, instructing the second AP MLD to perform roaming preparation for the non-AP MLD based on the first link reconfiguration request, transmitting, to the non-AP MLD, a first link reconfiguration response indicating that the second AP MLD is prepared for roaming, after transmitting the first link reconfiguration response, receiving, from the non-AP MLD, a second link reconfiguration request requesting deletion of the roaming preparation at the second AP MLD, and instructing the second AP MLD to delete the roaming preparation based on the second link reconfiguration request.

According to another embodiment, a first AP MLD includes one or more memories and one or more processors communicatively coupled to the one or more memories. The one or more processors, individually or collectively, perform an operation that includes receiving, from a non-AP MLD, a link reconfiguration request indicating that the non-AP MLD is requesting to roam to a second AP MLD, instructing the second AP MLD to begin roaming preparation based on the link reconfiguration request, after receiving the link reconfiguration request, receiving, from the non-AP MLD, a first link reconfiguration notify frame indicating that the roaming preparation at the second AP MLD should be deleted, and instructing the second AP MLD to delete the roaming preparation based on the first link reconfiguration notify frame.

According to another embodiment, a method includes receiving, by a first AP MLD and from a non-AP MLD, a first link reconfiguration request indicating that the non-AP MLD is requesting to perform roaming preparation for a second AP MLD, instructing, by the first AP MLD, the second AP MLD to perform roaming preparation for the non-AP MLD based on the first link reconfiguration request, transmitting, by the first AP MLD and to the non-AP MLD, a first link reconfiguration response indicating that the second AP MLD is prepared for roaming, after transmitting the first link reconfiguration response, receiving, by the first AP MLD and from the non-AP MLD, a second link reconfiguration request requesting deletion of the roaming preparation at the second AP MLD, and instructing, by the first AP MLD, the second AP MLD to delete the roaming preparation based on the second link reconfiguration request.

### EXAMPLE EMBODIMENTS

Because seamless roaming involves a target access point multi-link device (AP MLD) (which may also be referred to as an access point) adding links for a non-access point multi-link device (non-AP MLD) (which may also be referred to as a device or client) that may roam to the target AP MLD, it may be possible to use enhanced versions of link reconfiguration requests and link reconfiguration responses to implement a seamless roam. As part of seamless roaming (also be referred to as seamless mobility domain (SMD) basic service set (BSS) transition (ST) or SMD roaming), a non-AP MLD may be allowed to perform roaming preparation with multiple target AP MLDs up to a maximum limit (which may be referred to as “Maximum Number Of Prepared Target AP MLDs” in 802.11bn) to add links (and reserve resources) at multiple target AP MLDs. When the non-AP MLD reaches this limit, subsequent roaming preparation requests are rejected for that non-AP MLD.

The present disclosure describes a network that allows a non-AP MLD to delete (or cancel) a previous roaming preparation with a target AP MLD. The non-AP MLD may communicate a link reconfiguration request (e.g. an ultra high reliability (UHR) link reconfiguration request) to a serving AP MLD to request to prepare the target AP MLD for roam, which initiates roaming preparation at the target AP MLD. The target AP MLD sends a response to the serving AP MLD indicating the status and outcome for the roaming preparation, and the serving AP MLD transmits a link reconfiguration response to the non-AP MLD to provide the outcome for roaming preparation. The non-AP MLD may communicate another link reconfiguration request (or a link reconfiguration notify frame in some embodiments) to the serving AP MLD to delete the roaming preparation at the target AP MLD. The serving AP MLD may then signal the target AP MLD to delete the roaming preparation for the non-AP MLD at the target AP MLD. In some embodiments, the non-AP MLD may combine its request for deleting roaming preparation for a first target AP MLD with its request for (adding) roaming preparation for a second target AP MLD in the same link reconfiguration request sent to the serving AP MLD. The serving AP MLD may then signal to the first target AP MLD to delete roaming preparation for the non-AP MLD and signal to the second target AP MLD) to add roaming preparation for the non-AP MLD.

In some embodiments, the non-AP MLD may combine the request for deleting roaming preparation for a target AP MLD with the request for (adding) roaming preparation for the same target AP MLD in the same link reconfiguration request sent to the serving AP MLD, effectively updating the previous roaming preparation for the target AP MLD. In this case, the non-AP MLD uses the delete and add operations for roaming preparation to update roaming preparation for a target AP MLD. The UHR link reconfiguration request includes the updated set of parameters for roaming preparation for the target AP MLD. The serving AP MLD may then signal to the target AP MLD to delete the previous roaming preparation for the non-AP MLD and perform a new roaming preparation for the non-AP MLD based on the updated set of parameters indicated for roaming preparation.

In some embodiments, to update the roaming preparation for a target AP MLD, the non-AP MLD sends a link reconfiguration request with the updated set of parameters for roaming preparation for the target AP MLD to the serving AP MLD. The serving AP MLD may then signal to the target AP MLD to update the previous roaming preparation for the non-AP MLD based on the updated set of parameters indicated for roaming preparation. In this case, there is no explicit delete roaming preparation operation signaled for the target AP MLD in the link reconfiguration request.

In certain embodiments, the network provides several technical advantages. For example, the network may allow a non-AP MLD to delete a roaming preparation with a target AP MLD so that the non-AP MLD may be allowed to initiate a roaming preparation with another target AP MLD. As another example, the network may allow the non-AP MLD to delete roaming preparation with a target AP MLD if the non-AP MLD will no longer roam to the target AP MLD, which conserves resources at the target AP MLD and in the network. As another example, the network may allow the non-AP MLD to update a roaming preparation with a target AP MLD if the non-AP MLD should update the parameters for roaming preparation (e.g., due to changes in conditions such as RSSI, channel load, traffic profiles or movement of the non-AP MLD).

As an example, after a non-AP MLD has performed roaming preparation with a target AP MLD, it is possible that the non-AP MLD may change the target AP MLD selection (e.g., due to changes in received signal strength indicator (RSSI), channel load, movement of the non-AP MLD, etc.). In this scenario, the non-AP MLD may delete the previous roaming preparation with target AP MLD before the non-AP MLD performs roaming preparation or directly roaming execution with another target AP MLD. If the non-AP MLD keeps preparing new target AP MLDs without deleting any previous roaming preparations, then this can lead to reserving unwanted resources and links on target AP MLDs and hence suboptimal use of resources. It may be beneficial to provide a process that can be robust to avoid unwanted resource reservation and avoids unnecessary overhead and burdens on the non-AP MLD to first delete previous roaming preparations before preparing new the target AP MLD.

If roaming preparation is allowed for multiple target AP MLDs, then after the non-AP MLD has already prepared a first target AP MLD, a follow-up link reconfiguration request for roaming preparation may be interpreted as preparation for a second target AP MLD by the serving AP MLD. Then, roaming preparation may be performed for this second target AP MLD and also the first target AP MLD, when in fact, the intention may be to keep roaming preparation only with the second (or latest) target AP MLD. If the non-AP MLD keeps preparing the new target AP MLDs without deleting any previous roaming preparations, unwanted links and resources on target AP MLDs may be reserved, which is a suboptimal use of resources. It may be beneficial to provide a process for the non-AP MLD to signal that the non-AP MLD is no longer interested in previous roaming preparations (e.g., because conditions have changed at the non-AP MLD, such as changes in RSSI, channel load, traffic profiles or movement of the non-AP MLD).

There may be explicit signaling in the link reconfiguration request (e.g., a UHR link reconfiguration request serving as roaming preparation request or roaming execution request) to indicate that one or more previous roaming preparations (should be deleted. For example, the link reconfiguration request may include one or more elements (such as one or more reconfiguration ML elements) that indicates deletion of one or more previous roaming preparations.

As another example, this signaling could take the form of a roaming sequence number, which is incremented for every new seamless roaming sequence (comprising of one or more roaming preparations and a roaming execution) that the non-AP MLD initiates. The serving AP MLD may delete any roaming preparations performed previously if the non-AP MLD receives a link reconfiguration request with a higher roaming sequence number. The non-AP MLD may use a field (e.g., a roaming sequence number) in a link reconfiguration request (e.g., serving as a roaming request) to tie roaming preparations and roaming execution that belong to the same seamless roaming sequence. The non-AP MLD may increment the roaming sequence number for every new seamless roaming sequence that the non-AP MLD initiates. Both roaming preparation and roaming execution requests may include the same roaming sequence number. The non-AP MLD may also signal that the non-AP MLD is starting a new seamless roaming sequence by incrementing the roaming sequence number in the next link reconfiguration request (which signals an implicit deletion for previous roaming preparations). A serving AP MLD may delete the previous roaming preparations if the serving AP MLD receives a roaming preparation or execution request with an incremented roaming sequence number.

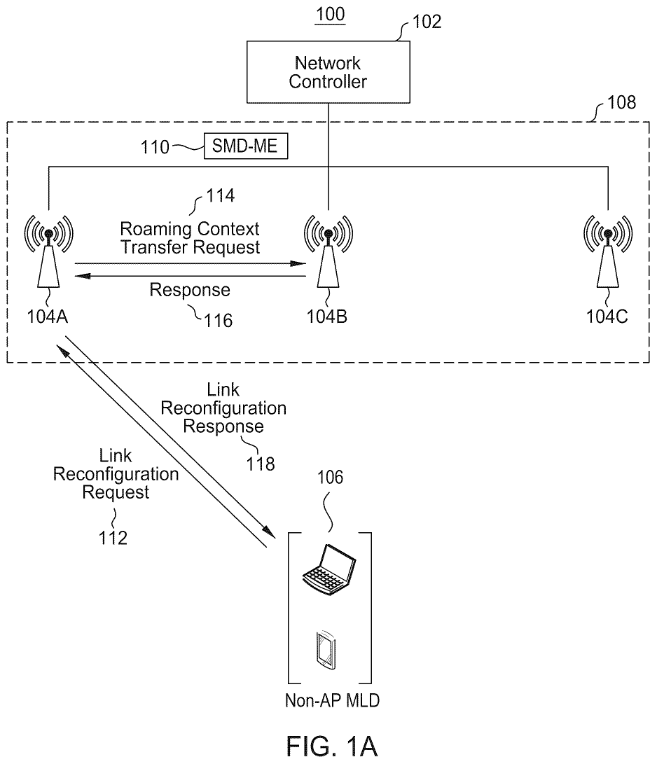

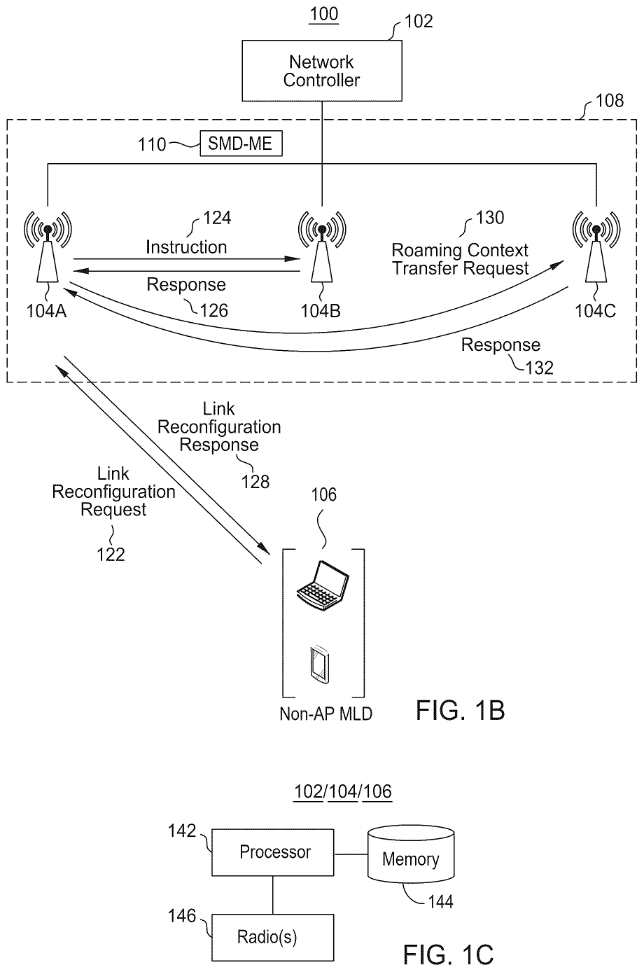

FIG. 1A illustrates an example system 100. As seen in FIG. 1A, the system 100 includes a network controller 102, AP MLDs 104 (e.g., AP MLDs 104A, 104B, and 104C) and one or more non-AP MLDs 106. Generally, the system 100 allows the AP MLDs 104 and the non-AP MLD 106 to use link reconfiguration requests and responses to perform roaming preparations. The AP MLDs 104 may be part of an SMD 108, and the non-AP MLD is associated with an SMD management entity (SMD-ME) 110 of the SMD 108.

The network controller 102 facilitates or manages the communication in the system 100. As an example, the network controller 102 may manage the connections between the AP MLDs 104 and the non-AP MLD 106. As another example, the network controller 102 may manage the connections and traffic between the AP MLDs 104.

An AP MLD 104 may be a network device that facilitates wireless communication (e.g., Wi-Fi communication) in the system 100. The non-AP MLD 106 connects to the AP MLD 104, and the AP MLD 104 may facilitate communication to and from the non-AP MLD 106. For example, the AP MLD 104 may receive messages from the non-AP MLD 106 and direct those messages towards their destination. As another example, the AP MLD 104 may receive messages intended for the non-AP MLD 106 and direct those messages to the non-AP MLD 106. The AP MLD 104 may also exchange messages with the network controller 102 or with other AP MLDs 104. Multiple AP MLDs 104 may be implemented in the same physical access point.

A non-AP MLD 106 may be any suitable device for communicating with components of the system 100. As an example and not by way of limitation, the non-AP MLD 106 may be a computer, a laptop, a wireless or cellular telephone, an electronic notebook, a personal digital assistant, a tablet, or any other device capable of receiving, processing, storing, or communicating information with other components of the system 100. The non-AP MLD 106 may be a wearable device such as a virtual reality or augmented reality headset, a smart watch, or smart glasses. The non-AP MLD 106 may also include a user interface, such as a display, a microphone, keypad, or other appropriate terminal equipment. The non-AP MLD 106 may include a hardware processor, memory, or circuitry configured to perform any of the functions or actions of the non-AP MLD 106 described herein. For example, a software application designed using software code may be stored in the memory and executed by the processor to perform the functions of the non-AP MLD 106. Multiple non-AP MLDs 106 may be implemented in the same physical device.

The non-AP MLD 106 may roam between AP MLDs 104 in the system 100. For example, the non-AP MLD 106 may initially be connected through the AP MLD 104A. If the non-AP MLD 106 moves further from the AP MLD 104A and closer to the AP MLD 104B, the non-AP MLD 106 may determine that the non-AP MLD 106 should roam from the AP MLD 104A to the AP MLD 104B for an improved connection. The non-AP MLD 106 may then communicate a roaming preparation request to the AP MLD 104A, and the AP MLD 104A may communicate with the AP MLD 104B to prepare for the roam. When roaming preparation is complete, the non-AP MLD 106 may execute the roam from the AP MLD 104A to the AP MLD 104B.

An AP MLD 104A and the non-AP MLD 106 may use link reconfiguration requests and link reconfiguration responses to adjust the set of links used by the AP MLD 104A and the non-AP MLD 106 using add link and delete link operations. The AP MLD 104A and the non-AP MLD 106 may also use link reconfiguration requests and link reconfiguration responses to perform seamless roaming to a target AP MLD. The link reconfiguration requests may operate as roaming requests, and the link reconfiguration responses may operate as roaming responses.

In some embodiments, the link reconfiguration request may be a UHR link reconfiguration request frame and the link reconfiguration response may be a UHR link reconfiguration response frame, which are UHR variants of link reconfiguration request and link reconfiguration response frames. In addition,, the link reconfiguration request used for roaming preparation may be an ST preparation request and the link reconfiguration response used for roaming preparation may an ST preparation response. The ST preparation request and ST preparation response are UHR link reconfiguration request and response frames respectively, with a Type field value indicating ST preparation or roaming preparation. Similarly,, the link reconfiguration request used for roaming execution may be an ST execution request and the link reconfiguration response used for roaming execution may be an ST execution response. The ST execution request and ST execution response are UHR link reconfiguration request and response frames respectively, with a Type field value indicating ST execution or roaming execution.

In the example of FIG. 1A, the non-AP MLD may request to roam from the AP MLD 104A to the AP MLD 104B by transmitting a link reconfiguration request 112 to the AP MLD 104A, which indicates a request to prepare a target AP MLD for seamless roaming. The link reconfiguration request 112 may request that the AP MLD 104B (which is the target AP MLD for roaming preparation) adds one or more links for the non-AP MLD 106 as part of roaming preparation. The link reconfiguration request 112 may be a UHR link reconfiguration request frame (a UHR variant of a link reconfiguration request).

The AP MLD 104A may instruct the AP MLD 104B to begin roaming preparation in response to the link reconfiguration request 112 using a roaming context transfer request 114 (e.g., by communicating some of the information in the link reconfiguration request 112 to the AP MLD 104B in the roaming context transfer request 114). The AP MLD 104B may then perform roaming preparation (e.g., by adding one or more links for the non-AP MLD 106) using the information in the roaming context transfer request 114.

The AP MLD 104B may then communicate a response 116 to the AP MLD 104A indicating the status of the roaming preparation. For example, the response 116 may indicate that the one or more links at the AP MLD 104B have been added successfully and that roaming preparation is complete. The AP MLD 104A may then transmit a link reconfiguration response 118 to the non-AP MLD to indicate that the roaming preparation is complete. The link reconfiguration response 118 may be a UHR link reconfiguration response frame (a UHR variant of a link reconfiguration response).

At a subsequent time, the non-AP MLD 106 may determine that the non-AP MLD 106 should roam to another AP MLD (e.g., the AP MLD 104C) (e.g., due to changes in RSSI, channel load, traffic profiles or movement of the non-AP MLD 106). FIG. 1B shows the system 100 of FIG. 1A deleting a previous roaming preparation. The non-AP MLD 106 may communicate a link reconfiguration request 122 to the AP MLD 104A to signal that one or more previous roaming preparations should be deleted. For example, the link reconfiguration request 122 may include fields/elements or a roaming sequence number that signal that previous roaming preparations should be deleted. The link reconfiguration request 122 may be a UHR link reconfiguration request frame (a UHR variant of a link reconfiguration request). In response to the link reconfiguration request 122, the AP MLD 104A communicates an instruction 124 to the AP MLD 104B to delete the previous roaming preparation. The AP MLD 104B may then delete the roaming preparation with the non-AP MLD 106. For example, the AP MLD 104B may remove or delete any links added for the non-AP MLD 106 during roaming preparation (e.g., as shown in FIG. 1A) and delete any resource reservations and context information for the non-AP MLD. In this manner, resources at the AP MLD 104B may be conserved.

The AP MLD 104B may then communicate a response 126 to the AP MLD 104A indicating that the roaming preparation has been deleted. The AP MLD 104A may communicate a link reconfiguration response 128 to the non-AP MLD 106 to indicate that the previous roaming preparation at the AP MLD 104B has been deleted. The link reconfiguration response 128 may be a UHR link reconfiguration response frame (a UHR variant of a link reconfiguration response).

In some embodiments, the link reconfiguration request 122 may signal that multiple roaming preparations should be deleted. In response, the AP MLD 104A may communicate instructions 124 to multiple AP MLDs to delete previous roaming preparations between those AP MLDs and the non-AP MLD.

In certain embodiments, the link reconfiguration request 122 may also request that roaming preparation be initiated with another AP MLD in addition to requesting deletion of one or more previous roaming preparations. For example, the link reconfiguration request 122 may request roaming preparation with the AP MLD 104C (in addition to deleting the previous roaming preparation with the AP MLD 104B). This may be desired when the non-AP MLD 106 has reached the maximum limit allowed for preparing target AP MLDs (as defined by the Max Number Of Prepared Target AP MLDs limit) and intends to prepare another target AP MLD. In this case, the non-AP MLD may signal to delete a previous roaming preparation and add another roaming preparation, thus still meeting the Max Number Of Prepared Target AP MLDs limit. Afte receiving such a link reconfiguration request 122, in response, the AP MLD 104A communicates the instruction 124 and receives the response 126 as described above to delete roaming preparation at target AP MLD 104B. In addition, the AP MLD 104A may communicate a roaming context transfer request 130 to the AP MLD 104C to initiate roaming preparation at the AP MLD 104C. The AP MLD 104C may then perform roaming preparation to prepare the AP MLD 104C for the non-AP MLD (e.g., by adding one or more requested links for the non-AP MLD 106 and reserving resources for the non-AP MLD at the AP MLD 104C). The AP MLD 104C may then communicate a response 132 to the AP MLD 104A to indicate that roaming preparation is complete. Then the link reconfiguration response 128 from the AP MLD 104A to the non-AP MLD 106 may indicate that the roaming preparation at the AP MLD 104C is complete (and the links added by the AP MLD 104C) in addition to indicating that the roaming preparation is deleted for the target AP MLD 104B. The link reconfiguration response 128 may be a UHR link reconfiguration response frame (a UHR variant of a link reconfiguration response).

FIG. 1C illustrates an example network controller 102, AP MLD 104, or non-AP MLD 106 of the system 100 of FIG. 1A. As seen in FIG. 1B, the network controller 102, AP MLD 104, or non-AP MLD 106 includes a processor 142, a memory 144, and one or more radios 146.

The processor 142 is any electronic circuitry, including, but not limited to one or a combination of microprocessors, microcontrollers, application specific integrated circuits (ASIC), application specific instruction set processor (ASIP), or state machines, that communicatively couples to the memory 144 and controls the operation of the network controller 102, AP MLD 104, or non-AP MLD 106. The processor 142 may be 8-bit, 16-bit, 32-bit, 64-bit or of any other suitable architecture. The processor 142 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 142 may include other hardware that operates software to control and process information. The processor 142 executes software stored on the memory 144 to perform any of the functions described herein. The processor 142 controls the operation and administration of the network controller 102, AP MLD 104, or non-AP MLD 106 by processing information (e.g., information received from the memory 144 and radios 146). The processor 142 is not limited to a single processing device and may encompass multiple processing devices contained in the same device or computer or distributed across multiple devices or computers. The processor 142 is considered to perform a set of functions or actions if the multiple processing devices collectively perform the set of functions or actions, even if different processing devices perform different functions or actions in the set.

The memory 144 may store, either permanently or temporarily, data, operational software, or other information for the processor 142. The memory 144 may include any one or a combination of volatile or non-volatile local or remote devices suitable for storing information. For example, the memory 144 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 144, a disk, a CD, or a flash drive. In particular embodiments, the software may include an application executable by the processor 142 to perform one or more of the functions described herein. The memory 144 is not limited to a single memory and may encompass multiple memories contained in the same device or computer or distributed across multiple devices or computers. The memory 144 is considered to store a set of data, operational software, or information if the multiple memories collectively store the set of data, operational software, or information, even if different memories store different portions of the data, operational software, or information in the set.

The radios 146 may communicate messages or information using different communication technologies. For example, the network controller 102, AP MLD 104, or non-AP MLD 106 may use one or more of the radios 146 for Wi-Fi communications. The network controller 102, AP MLD 104, or non-AP MLD 106 may use one or more of the radios 146 to transmit messages and one or more of the radios 146 to receive messages. The network controller 102, AP MLD 104, or non-AP MLD 106 may include any number of radios 146 to communicate using any number of communication technologies.

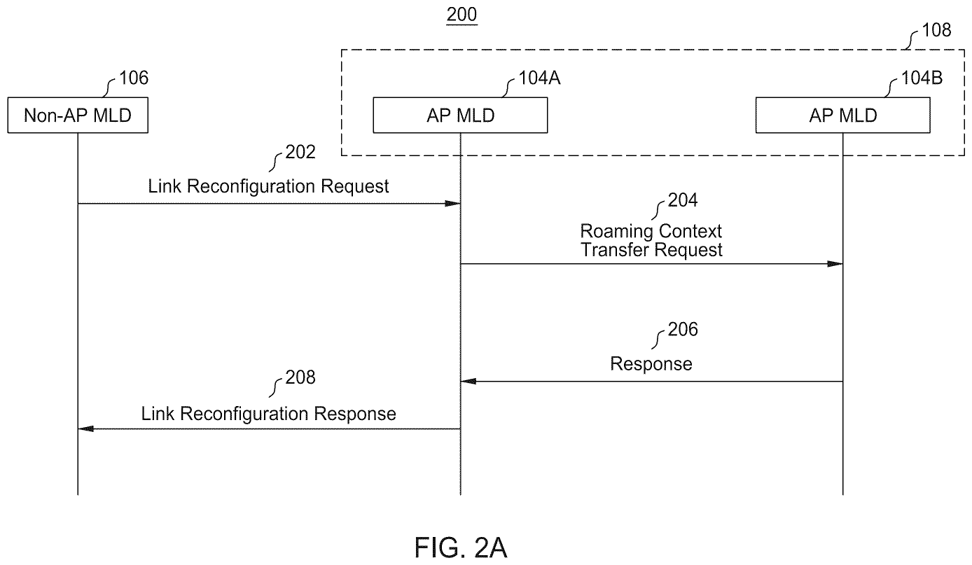

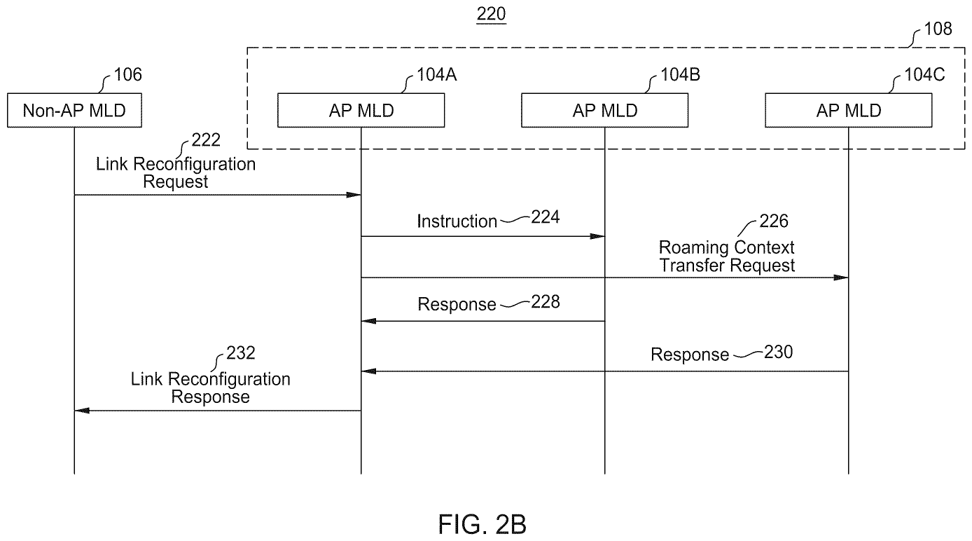

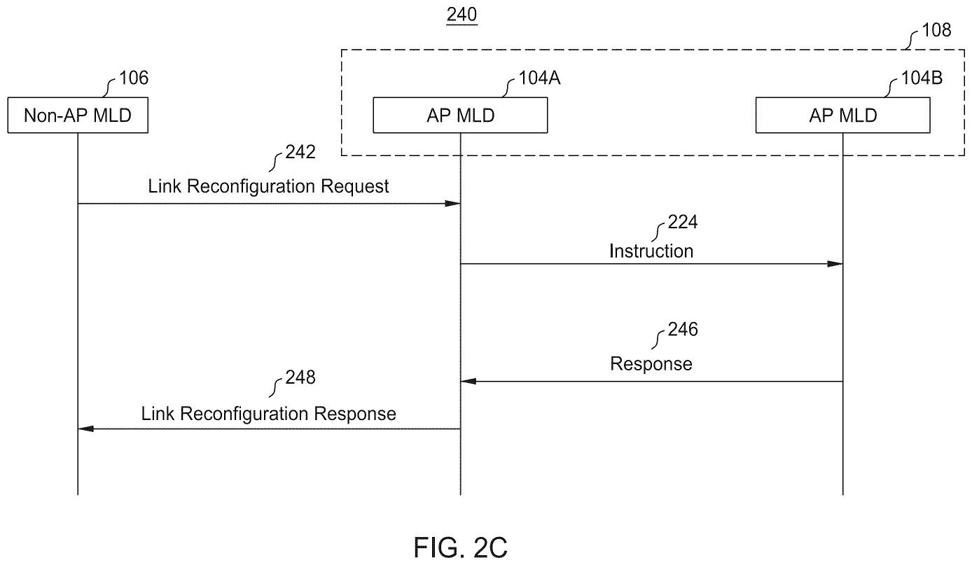

FIG. 2A illustrates an example operation 200 performed by the system 100 of FIG. 1A. As seen in FIG. 2A, the non-AP MLD 106, the AP MLD 104A, and the AP MLD 104B perform the operation 200. By performing the operation 200, the non-AP MLD 106 uses link reconfiguration requests to initiate roaming preparations at one or more target AP MLDs.

The non-AP MLD 106 begins by communicating a link reconfiguration request 202 to the AP MLD 104A (which may be a serving AP MLD for the non-AP MLD 106). The link reconfiguration request 202 may indicate that the non-AP MLD 106 requests to roam to the AP MLD 104B, which may be in the same SMD 108 as the AP MLD 104A. For example, the link reconfiguration request 202 may request that the AP MLD 104B add one or more links for the non-AP MLD 106. In response the AP MLD 104A instructs the AP MLD 104B to begin roaming preparation using a roaming context transfer request 204 (e.g., by communicating the roaming context transfer request 204 to the AP MLD 104B). The roaming context transfer request 204 may signal that the AP MLD 104B should perform roaming preparation for the non-AP MLD 106. The AP MLD 104B may then perform roaming preparation (e.g., add one or more links and reserve resources for the non-AP MLD 106).

The AP MLD 104B may communicate a response 206 to the AP MLD 104A indicating that roaming preparation is complete. The response 206 may also indicate the one or more links added at the AP MLD 104B for the non-AP MLD 106. The AP MLD 104A communicates a link reconfiguration response 208 to the non-AP MLD 106 to indicate that the roaming preparation at the AP MLD 104B is complete.

After roaming preparation at the AP MLD 104B is complete, the non-AP MLD 106 may determine that the non-AP MLD 106 should roam to another AP MLD instead of the AP MLD 104B. In response, the non-AP MLD 106 may determine that the roaming preparation with the AP MLD 104B should be deleted. FIG. 2B illustrates an example operation 220 performed by the system 100 of FIG. 1A. As seen in FIG. 2B, the non-AP MLD 106, the AP MLD 104A, the AP MLD 104B, and the AP MLD 104C (in the same SMD 108) perform the operation 220. By performing the operation 220, the non-AP MLD 106 uses link reconfiguration requests to delete the previous roaming preparation completed at the AP MLD 104B (e.g., as shown in FIG. 2A) and add roaming preparation for another target AP MLD 104C.

The non-AP MLD 106 may communicate a link reconfiguration request 222 (which may be a ultra high reliability (UHR) link reconfiguration request) to the AP MLD 104A to indicate that the roaming preparation with the AP MLD 104B should be deleted. For example, the link reconfiguration request 222 may indicate that added links for the non-AP MLD should be deleted or removed and resources should not be reserved anymore for the non-AP MLD at the AP MLD 104B. The link reconfiguration request 222 may also indicate that roaming preparation should be performed with the AP MLD 104C so that the non-AP MLD 106 may roam to the AP MLD 104C.

In response, the AP MLD 104A may communicate an instruction 224 to the AP MLD 104B to instruct the AP MLD 104B to delete the roaming preparation with the non-AP MLD 106. The AP MLD 104B may then delete the roaming preparation with the non-AP MLD 106. For example, the AP MLD 104B may remove or delete the links that were previously added for the non-AP MLD 106 as part of roaming preparation and remove any reserved resources (e.g. SCS or block ack resources). The AP MLD 104A may also communicate a roaming context transfer request 226 to the AP MLD 104C to instruct the AP MLD 104C to initiate roaming preparation. In response, the AP MLD 104C may add one or more requested links for the non-AP MLD 106 (and reserve resources for the non-AP MLD). The AP MLD 104B may communicate a response 228 to the AP MLD 104A to indicate that the roaming preparation for the non-AP MLD 106 at the AP MLD 104B has been deleted. The AP MLD 104C may communicate a response 230 to the AP MLD 104A to indicate that the roaming preparation for the non-AP MLD 106 at the AP MLD 104C has been completed and one or more links have been added.

The AP MLD 104A may communicate a link reconfiguration response 232 to the non-AP MLD 106. The link reconfiguration response 232 may indicate a status of the deletion of the roaming preparation at the AP MLD 104B. For example, the link reconfiguration response 232 may indicate that the deletion of roaming preparation was successful. In some embodiments, deleting a roaming preparation is expected to be successful and receiving the link reconfiguration response itself signals that the deletion of roaming preparation was successful. The link reconfiguration response 232 may also indicate a status of the roaming preparation at the target AP MLD 104C. For example, the link reconfiguration response 232 may indicate that the roaming preparation at the AP MLD 104C is complete and indicate the set of links that are added at the target AP MLD 104C for the non-AP MLD. In this manner, the non-AP MLD 106 may use the link reconfiguration request 222 to delete a previous roaming preparation for a target AP MLD and to add a new roaming preparation for another target AP MLD.

In some embodiments, the AP MLD 106 may use the link reconfiguration request 222 to delete a previous roaming preparation for a target AP MLD, without adding a new roaming preparation for another target AP MLD. For example, in the link reconfiguration request 222, the non-AP MLD 106 may request to delete the previous roaming preparation for target AP MLD 104B, and then the link reconfiguration response 232 indicates that the previous roaming preparation for target AP MLD 104B has been deleted. In some instances, the non-AP MLD 106 may use a link reconfiguration request to delete a previous roaming preparation and to request to add a new roaming preparation for the same target AP MLD. In this manner, the non-AP MLD may update the roaming preparation at the target AP MLD. FIG. 2C illustrates an example operation 240 performed by the system 100 of FIG. 1A. As seen in FIG. 2C, the non-AP MLD 106, the AP MLD 104A, and the AP MLD 104B (in the same SMD 108) perform the operation 240. By performing the operation 240, the non-AP MLD 106 uses link reconfiguration requests to update the previous roaming preparation completed at the AP MLD 104B (e.g., as shown in FIG. 2A).

The non-AP MLD 106 may communicate a link reconfiguration request 242 (which may be a ultra high reliability (UHR) link reconfiguration request) to the AP MLD 104A to indicate that the roaming preparation with the AP MLD 104B should be deleted. The link reconfiguration request 242 may also indicate that the AP MLD 104B should perform roaming preparation with the new set of parameters indicated in the request, so that the non-AP MLD 106 may roam to the AP MLD 104B.

In response, the AP MLD 104A may communicate an instruction 224 to the AP MLD 104B to instruct the AP MLD 104B to delete the roaming preparation for the non-AP MLD 106. The AP MLD 104B may then delete the roaming preparation with the non-AP MLD 106. For example, the AP MLD 104B may remove or delete the links that were previously added for the non-AP MLD 106 as part of roaming preparation. The instruction 224 may also instruct the AP MLD 104B to perform roaming preparation for the non-AP MLD 106. In response, the AP MLD 104B may add one or more links or reserve resources for the non-AP MLD 106, based on the roaming preparation request received in the instruction 224. The AP MLD 104B may communicate a response 246 to the AP MLD 104A to indicate that roaming preparation for the non-AP MLD 106 at the AP MLD 104B has been updated, based on the deletion of previous roaming preparation and new roaming preparation request received in instruction 224, and indicate the updated set of links added and resources reserved for the non-AP MLD 106 at the AP MLD 104B.

The AP MLD 104A may communicate a link reconfiguration response 248 to the non-AP MLD 106. The link reconfiguration response 248 may indicate a status of the roaming preparation at the AP MLD 104B. For example, the link reconfiguration response 248 may indicate that the deletion of previous roaming preparation was successful (in some embodiments, roaming preparation deletion may be defined or expected to be successful). The link reconfiguration response 248 may also indicate a status of the roaming preparation at the AP MLD 104B. For example, the link reconfiguration response 248 may indicate that the roaming preparation at the AP MLD 104B is complete with updated set of roaming preparation parameters provided in the link reconfiguration request 242. In this manner, the non-AP MLD 106 may use the link reconfiguration request 242 to delete a previous roaming preparation and to initiate a new roaming preparation at the same AP MLD 104B, which effectively updates the roaming preparation at the AP MLD 104B.

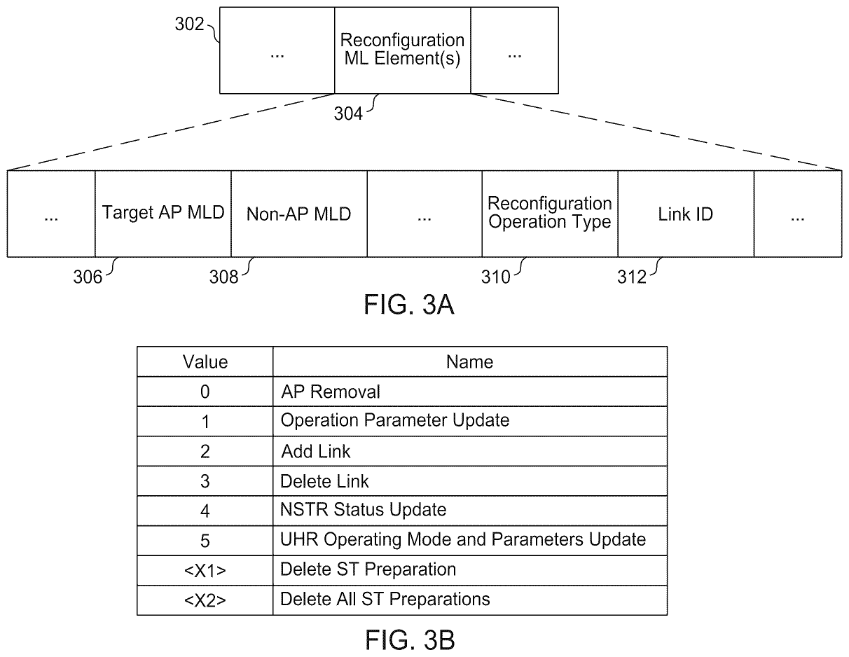

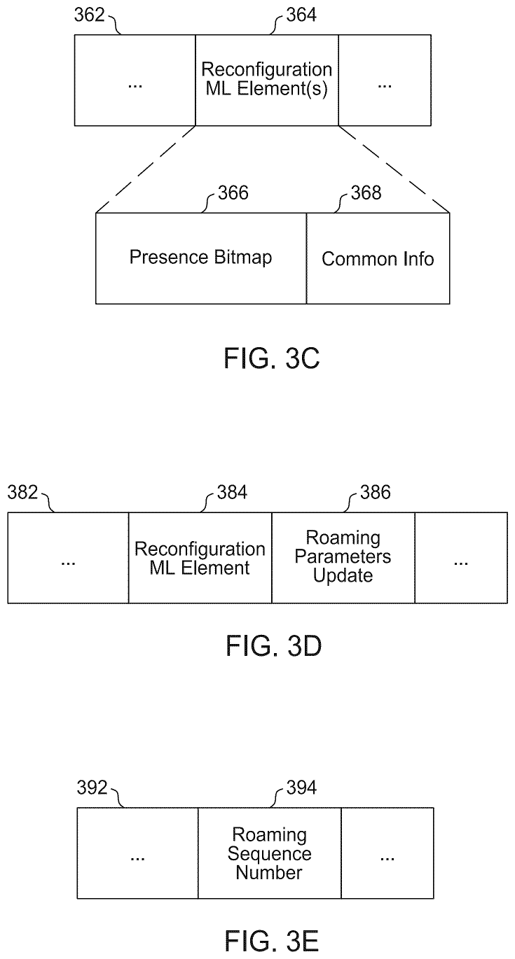

FIG. 3A illustrates an example message 302 in the system 100 of FIG. 1A. Generally, the message 302 may be a link reconfiguration request (e.g., the link reconfiguration request 222 or 242 shown in FIGS. 2B and 2C). The message 302 may include fields that signal that deletion of a roaming preparation is being requested.

As seen in FIG. 3A, the message 302 includes a field 304 that includes one or more reconfiguration multi-link (ML) elements. Generally, each reconfiguration ML element may indicate deletion or cancellation of a roaming preparation at a target AP MLD for the non-AP MLD sending the message 302. Multiple reconfiguration ML elements may be included to indicate deleting roaming preparation at multiple target AP MLDs for the non-AP MLD. Each reconfiguration ML element includes additional fields 306, 308, 310, and 312. The field 306 may identify the target AP MLD (e.g., using an MLD media access control (MAC) address of the target AP MLD) for which the roaming preparation is requested to be deleted. The field 308 may identify the non-AP MLD (e.g., using an MLD MAC address of the non-AP MLD) for which the roaming preparation is requested to be deleted at the target AP MLD. Fields 306 and 308 may be included in the common Info field of the reconfiguration ML element.

In the reconfiguration ML element, the field 310 may indicate a reconfiguration operation type, which may indicate a request for deletion of roaming preparation (e.g. indicate operation type to be delete ST preparation or delete roaming preparation). The field 312 may identify link ID for one of the links that is setup or added at the target AP MLD during roaming preparation. In some instances, the field 312 may be set to a predefined value (e.g., link ID 15 or set to reserved value (all zeroes)). In one embodiment, when deleting a roaming preparation, the links that were added at previous roaming preparation are deleted and deleting specific links or subset of links are not allowed as part of roaming deletion. The reconfiguration operation type field 310 and Link ID field 312 may be provided as part of a per-STA Profile subelement included in the reconfiguration ML element, in the STA Control field. In this manner, the reconfiguration ML element indicates the request that the roaming preparation at the target AP MLD is requested to be deleted for the non-AP MLD.

In some embodiments, the message 302 includes multiple reconfiguration ML elements, which may signal that multiple roaming preparations at multiple target AP MLDs are requested to be deleted. Each reconfiguration ML element may indicate deletion of roaming preparation for one target AP MLD as described above in FIG. 3A.

In some embodiments, deleting roaming preparation for a non-AP MLD at a target AP MLD results in the following: i) deletion of the links that are added for the non-AP MLD at the target AP MLD during roaming preparation, ii) removing any resource reservations for the non-AP MLD at the target AP MLD, and iii) deleting context information for the non-AP MLD at the target AP MLD.

In a first option, the reconfiguration ML element may indicate (e.g., using the reconfiguration operation type) deletion of roaming preparation for the non-AP MLD at the target AP MLD, which indicates request for deletion of the links that were added at the roaming preparation regardless of the link identified in the Link ID field 312. In this option, a single per-STA profile subelement is included in the reconfiguration ML element indicating a new reconfiguration operation type signaling ‘Delete ST preparation’ in the STA Control field (e.g., using a new value for the reconfiguration operation type, such as value 6 or another reserved value). The Link ID field in the STA Control field may be set as described above (e.g., either set to Link ID 15 or link ID of any of the added links or Link ID may be reserved (e.g., set to all zeroes)). The message 302 may include other fields, such as a STA Info field in the per-STA profile subelement in the reconfiguration ML element. In the STA Info field none of the existing fields (as used in 802.11be) may be included. In the per-STA profile subelement, in the STA Control field the bits indicating presence of fields in the STA Info field may be set to 0 and the corresponding fields are not included in the STA info field. Additionally or alternatively, a STA MAC address present bit may be set to 1 and the STA MAC address field may be included in the STA info field. In the per-STA profile subelement, in the STA Control field the complete profile field may be set to 0 and the STA Profile field is not included. Thus, in this case, a single per-STA profile element is included in the reconfiguration ML element to indicate deletion of roaming preparation, instead of including separate per-STA profile subelements for each link that is setup or prepared with the target AP MLD. This approach allows atomically removing the entire roaming preparation (deleting the added links) because the reconfiguration operation type explicitly provides that indication.

In a second option, the reconfiguration ML element includes a single per-STA profile subelement, similar to first option above. The per-STA profile subelement includes a reconfiguration operation type in a STA Control field to indicate roaming preparation deletion. However, in this case, instead of using a new reconfiguration operation type (e.g., ‘Delete ST preparation’ as described for the first option above), currently used ‘Delete Link’ reconfiguration operation type (type value 3 as used in 802.11be) is used to indicate that deletion of roaming preparation is requested. The Link ID field in the STA control field in the per-STA profile subelement may be set as described in the first option above. In this case, because the reconfiguration ML element is included as part of a link reconfiguration request for roaming preparation (e.g., the ST preparation request), any reconfiguration ML element which indicates ‘Delete link’ reconfiguration operation type may be considered as a request for deleting the entire roaming preparation. As a result, the ‘delete link’ reconfiguration operation type may be interpreted as a delete roaming preparation operation when the reconfiguration ML element is included as part of ST preparation request. Similar additional settings as in the first option described above can be applicable for STA control field, STA info field, and STA profile field in the per-STA profile subelement included in the reconfiguration ML element.

For both the first and second options, a new reconfiguration operation type value may be used to indicate a request for deleting the roaming preparations at one or more target AP MLDs that are already prepared for roaming. This new operation type may indicate ‘Delete all ST preparations’ or ‘Delete all roaming preparations’ to indicate deleting roaming preparations for prepared target AP MLDs. The non-AP MLD may include one per-non-AP MLD profile subelement in the reconfiguration ML element with this new type value in the STA control field to signal deletion of the previous roaming preparations. The target AP MLD MAC address may not be included in the common info field of the reconfiguration ML element because the request is to delete the roaming preparations, instead of deleting roaming preparation for specific target AP MLDs.

In some instances, the non-AP MLD may not delete only a subset of links on a target AP MLD after roaming preparation was performed for that target AP MLD. As a result, the roaming preparation is deleted as a whole, deleting the added/prepared links at the target AP MLD, and only the subset of links may not be removed for an already prepared target AP MLD.

FIG. 3B illustrates an example table 320 used in the system 100 of FIG. 1A. Generally, the table 320 shows the meaning of different values for a reconfiguration operation type (e.g., as shown in the field 306 in FIG. 3A) used in a reconfiguration ML element and shows new reconfiguration operation types added for deleting roaming preparations.

As seen in FIG. 3B, the table 320 indicates some already defined values for the reconfiguration operation type field, as used in 802.11be and 802.11bn. These include values 0 to 5. A reconfiguration operation type value 0 indicates AP removal. A reconfiguration operation type value 1 indicates an operation parameter update. A reconfiguration operation type value 2 indicates add link (and is used to add a link to multi-link setup for a non-AP MLD). A reconfiguration operation type value 3 indicates delete link (and is used to delete a link from the multi-link setup for a non-AP MLD). A reconfiguration operation type value 4 indicates non-simultaneous transmit and receive (NSTR) status update. A reconfiguration operation type value 5 indicates a UHR operating mode and parameters update.

The table 320 indicates two additional reconfiguration operation types used for deleting roaming preparations (which is also referred to as deleting ST (SMD BSS transition) preparations). These include the following two new reconfiguration operation types:
i) ‘Delete ST Preparation’: Indicates a request for deleting ST preparation or roaming preparation for a specific target AP MLD. This operation type may be assigned any of the reserved values of the reconfiguration operation type field (shown as X1 in the table).
ii) ‘Delete All ST Preparations’: Indicates a request for deleting the previous ST preparations or the previous roaming preparations at target AP MLDs. In this case, roaming preparation is deleted for every target AP MLD that was previously prepared. This operation type may be assigned any of the reserved values of the reconfiguration operation type field (shown as X2 in the table).

These new reconfiguration operation type values may be used in a link reconfiguration request (e.g., the message 302 shown in FIG. 3A) in the reconfiguration ML element to signal request for deleting roaming preparations.

FIG. 3C illustrates an example message 362 in the system 100 of FIG. 1A. Generally, the message 362 may be a third option for a link reconfiguration request (e.g., the link reconfiguration request 206 shown in FIG. 2). As with the first and second options, the message 362 includes a field 364 that includes one or more reconfiguration ML elements, which may be used to signal deletion of one or more roaming preparations. Each reconfiguration ML element indicates roaming preparation deletion for one target AP MLD. The reconfiguration ML element includes a presence bitmap field 366 and includes a common info field 368. Although not illustrated, the message 362 may include other fields shown for the first and second options (e.g., in FIG. 3A).

In the example of FIG. 3C, the reconfiguration ML element may indicate a request to delete a roaming preparation in the presence bitmap field 366 or in the common info field 368. As a result, no per-STA profile subelement may be included in the reconfiguration ML element for indicating deletion of roaming preparation.

As an example, the presence bitmap field 366 may include a field or bit (e.g., a Delete ST Preparation′ field) that indicates whether a roaming preparation should be deleted. If this field or bit is set to 1, then the non-AP MLD may be requesting deletion of a roaming preparation for a target AP MLD indicated in the common info field. The presence bitmap may also include a field or bit to indicate whether every roaming preparation should be deleted. When this field or bit is set to 1, then the non-AP MLD may be requesting deletion of the previous roaming preparations.

As another example, a field indicating that a roaming preparation should be deleted may be included in the common info field. The presence of this field may be indicated based on a corresponding present bit in the presence bitmap. This field may include other indications (e.g., whether every previous roaming preparation should be deleted indicated using one bit, etc.).

In the first, second, and third options, if deletion of every previous roaming preparation is requested, then the target AP MLD MAC address may not be included in the common info field.

The non-AP MLD may signal a request for deletion of previous roaming preparations in the same link reconfiguration request which is requesting to perform a new roaming preparation with another target AP MLD. Additionally or alternatively, the non-AP MLD may send the request for deletion of previous roaming preparations separately (e.g., indicating only roaming preparation deletions).

In one case, a new type value may be used in the link reconfiguration request sent by the non-AP MLD to signal only deletion of roaming preparations. Then, this new type value may be used in the corresponding link reconfiguration response sent by the serving AP MLD in response. In one case, the status in the link reconfiguration response indicates success for deletion of roaming preparation or no explicit status is provided, and receiving the link reconfiguration response indicates to the non-AP MLD that the requested roaming preparations are deleted.

After receiving the link reconfiguration request indicating deletion of a previous roaming preparation, the serving AP MLD deletes the roaming preparation with the target AP MLD for that non-AP MLD. The deleted roaming preparations no longer counts towards a maximum limit defined for the maximum number of target AP MLDs that can be prepared for roaming preparation for the SMD to which the serving AP MLD and the target AP MLD belong.

The request for deleting a previous roaming preparation may generally be considered successful. If a link reconfiguration request included both a request for adding a new roaming preparation and a request for deleting one or more previous roaming preparations, then no explicit status may be provided in the link reconfiguration response for deletion of the roaming preparations. The status provided in the link reconfiguration response would correspond to adding the new roaming preparation. Even if the request for adding the new roaming preparation failed and indicated as such in the link reconfiguration response, the roaming preparation deletion may be considered successful. In one case, the SMD BSS transition parameters element in the link reconfiguration response can provide an explicit status for deletion of roaming preparations.

If the link reconfiguration request included only a request for deleting one or more previous roaming preparations, then the link reconfiguration response may provide a success status for roaming preparation deletion. For example, a success status may be provided for deletion of roaming preparations in the reconfiguration status list field included in the link reconfiguration response by setting the status field to indicate success and Link ID field to value 15 (or reserved value). Additionally or alternatively, the success status for deletion of roaming preparations may be provided in the SMD BSS transition parameters element included in the link reconfiguration response.

The non-AP MLD may consider that the roaming preparation is deleted for the one or more target AP MLDs for which roaming preparation deletion was requested in the link reconfiguration request, after the non-AP MLD receives the corresponding link reconfiguration response, even if there is no explicit status indicated for success of the roaming preparation deletion.

In one case, due to possible network issues, the deletion of roaming preparations may fail, and this failure may be signaled in the link reconfiguration response using a status code. Then, the non-AP MLD may retry deletion of the roaming preparation.

After a non-AP MLD performs a successful roaming execution with a target AP MLD (e.g., the non-AP MLD has successfully roamed to a target AP MLD), then the SMD or the previous serving AP MLD or the network may delete the previous roaming preparations for the non-AP MLD. The non-AP MLD may consider that the previous roaming preparations of the non-AP MLD are deleted once the non-AP MLD performs successful roaming execution with a target AP MLD.

Similarly, if a non-AP MLD goes below State 3 in the state machine with the SMD-ME (which implies that the non-AP MLD is no longer associated with the SMD-ME), then the roaming preparations for the non-AP MLD at one or more target AP MLDs are deleted at the network side. When a non-AP MLD is no longer associated with the SMD-ME, the non-AP MLD may consider that previous roaming preparations are deleted. If a non-AP MLD is disassociated or deauthenticated from the SMD-ME, then any of the roaming preparations for the non-AP MLD are deleted and the non-AP MLD may consider that previous roaming preparations are deleted.

FIG. 3D illustrates an example message 382 in the system 100 of FIG. 1A. Generally, the message 382 may be a link reconfiguration request (e.g., the link reconfiguration request 206 shown in FIG. 2). A non-AP MLD may communicate the message 382 to signal explicit deletion of every previous roaming preparation.

As seen in FIG. 3D, the message 382 includes fields 384 and 386. The field 384 includes a reconfiguration ML element. The field 386 includes a roaming parameters element (which may also be referred to as a SMD BSS Transition element). In some instances, the non-AP MLD may signal deletion of every previous roaming preparation in the reconfiguration ML element (e.g., in the common info field or in a per-STA profile subelement in the STA control field or STA info field). In some cases, the non-AP MLD may signal deletion of every previous roaming preparation in the roaming parameters element (e.g., by adding a field or bit in the common info field or another field).

FIG. 3E illustrates an example message 392 in the system 100 of FIG. 1A. Generally, the message 392 may be a link reconfiguration request (e.g., the link reconfiguration request 206 shown in FIG. 2). A non-AP MLD may communicate the message 392 to signal explicit deletion of every previous roaming preparation.

As seen in FIG. 3E, the message 392 includes a field 394 that indicates a roaming sequence number. The roaming sequence number ties together a series of seamless roaming procedures that belong to a same roaming sequence. Generally, the non-AP MLD may increment the roaming sequence number when the non-AP MLD may intend to delete every previous roaming preparation and start a new sequence of seamless roaming procedure. The serving AP MLD may delete every roaming preparation with a smaller roaming sequence number (e.g., the previous roaming preparations) when the serving AP MLD receives a roaming preparation request that has a higher roaming sequence number (while also taking into account any wraparound of the roaming sequence number).

The non-AP MLD signals a roaming sequence number in the link reconfiguration request. If multiple target AP MLDs are prepared for possible roaming, then every link reconfiguration request carries the same roaming sequence number. If the non-AP MLD intends to delete every previous roaming preparation, then the non-AP MLD increments the roaming sequence number in a subsequent link reconfiguration request sent for roaming preparation or roaming execution. An incremented roaming sequence number indicates to the serving AP MLD that a new roaming sequence (e.g., a new instance of roaming preparation procedures) is occurring and that every previous roaming preparation for the non-AP MLD should be deleted. The serving AP MLD may delete every previous roaming preparation if the serving AP MLD receives a link reconfiguration request with an incremented roaming sequence number.

The roaming sequence number may be provided to the target AP MLD from the serving AP MLD as part of the roaming preparation procedure. The roaming execution procedure may also carry the same roaming sequence number to tie the roaming execution with the roaming preparation. A target AP MLD may accept a request for roaming execution if the request has the same roaming sequence number as the roaming preparation at the target AP MLD for that non-AP MLD. Otherwise, the target AP MLD should reject the roaming execution.

Having a roaming sequence number may also address the cases when the network may not delete the other roaming preparations immediately (e.g., when multiple target AP MLDs performed roaming preparation), after a non-AP MLD has performed roaming execution. After a successful roaming execution is performed by the non-AP MLD, old roaming preparations may not be used by the non-AP MLD (which are associated with an older roaming sequence number). For any subsequent roaming operation, the non-AP MLD may increment the roaming sequence number, and any previous roaming preparations may no longer be valid for the new roaming procedure. This process may provide higher flexibility at the network by allowing for delayed or asynchronous deletion of prior roaming preparations, which are no longer applicable.

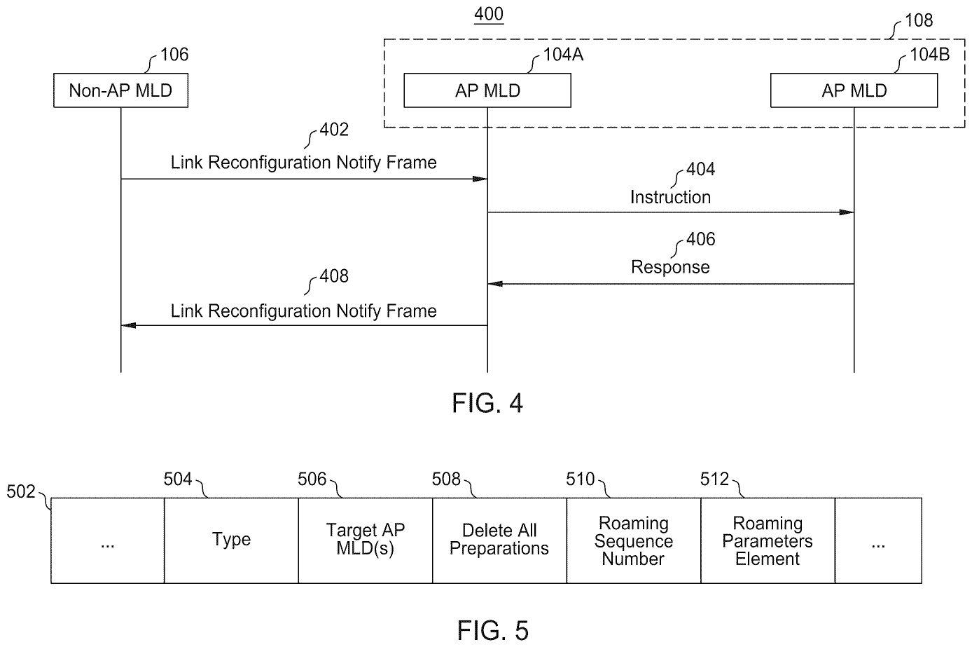

FIG. 4 illustrates an example operation 400 performed by the system 100 of FIG. 1A. As seen in FIG. 4, the non-AP MLD 106, the AP MLD 104A, and the AP MLD 104B (in the same SMD 108) perform the operation 400. By performing the operation 400, the non-AP MLD 106 uses link reconfiguration notify frames to delete previous roaming preparations at one or more target AP MLDs.

After the AP MLD 104B has performed roaming preparation (e.g., as shown in FIG. 2A), the non-AP MLD 106 may determine that the non-AP MLD 106 should roam to another AP MLD instead of the AP MLD 104B. In response, the non-AP MLD 106 may determine that the roaming preparation with the AP MLD 104B should be deleted. The non-AP MLD 106 may communicate a link reconfiguration notify frame 402 (which may also be referred to as a UHR link reconfiguration notify frame) to the AP MLD 104A to indicate that the roaming preparation with the AP MLD 104B should be deleted for the non-AP MLD. In response, the AP MLD 104A may communicate an instruction 404 to the AP MLD 104B to instruct the AP MLD 104B to delete the roaming preparation for the non-AP MLD 106. The AP MLD 104B may then delete the roaming preparation for the non-AP MLD 106. For example, the AP MLD 104B may remove or delete the links that were added for the non-AP MLD 106 and take other actions for roaming preparation deletion. The AP MLD 104B may communicate a response 406 to the AP MLD 104A to indicate that the roaming preparation with the non-AP MLD 106 has been deleted.

The AP MLD 104A may also communicate a link reconfiguration notify frame 408 to the non-AP MLD 106. The link reconfiguration notify frame 408 may indicate a status for the deletion of the roaming preparation at the AP MLD 104B. For example, the link reconfiguration notify frame 408 may indicate that the deletion was successful.

FIG. 5 illustrates an example message 502 in the system 100 of FIG. 1A. Generally, the message 502 may be a link reconfiguration notify frame (e.g., the link reconfiguration notify frame 406 shown in FIG. 4). A non-AP MLD may send the message 502 to delete previous roaming preparations with one or more target AP MLDs (e.g. if the non-AP MLD does not need to keep those roaming preparations or if the non-AP MLD has reached a maximum prepared target AP MLD limit and needs to prepare other AP MLDs). A new type value may be included for the message 502 that indicates a request for roaming preparation deletion.

As seen in FIG. 5, the message 502 includes fields 504, 506, 508, 510, and 512. The field 504 indicates a type, which may have a value that indicates a request for roaming preparation deletion or that a roaming preparation has been deleted. The field 506 identifies one or more target AP MLDs (e.g., using the MLD MAC addresses of the target AP MLDs). The field 508 indicates whether every previous roaming preparation are requested to be deleted. The field 510 includes a roaming sequence number, which may indicate a roaming sequence number as described above. The field 512 includes a roaming parameters element. In some embodiments, the message 502 may exclude some of these fields depending on an agreed format of the message 502 to accomplish a specific purpose.

As a first example, the message 502 may signal deletion of a roaming preparation for one or more target AP MLDs. The message 502 may include a field or element (e.g., the field 506) that indicates MAC addresses for one or more target AP MLDs for which the non-AP MLD is requesting deletion of roaming preparation.

As a second example, the message 502 may signal deletion of every previous roaming preparation. The message 502 may include a field or element (e.g., the field 508) to indicate deletion of every previous roaming preparation for the non-AP MLD. In one case, the type value (e.g., in the field 504) of the message 502 may indicate a request to delete every previous roaming preparation. As a result, the default behavior may be to delete every previous roaming preparation.

As a third example, if a roaming sequence number is used, then the roaming sequence number may be provided in the message 502 (e.g., in the field 510) to signal deletion of one or more roaming preparations corresponding to that roaming sequence number.

As a fourth example, the deletion of roaming preparations requested by the message 502 may be considered successful, and there may be no need for the AP MLD to send back a response. In some instances, the AP MLD sends back a message 502 (e.g., another link reconfiguration notify frame) to the non-AP MLD in response that either indicates explicit success status or no explicit status is provided. Receiving a response may indicate to the non-AP MLD that the requested roaming preparations are deleted.

As a fifth example, a new element (e.g., in the field 512) may be included in the message 502 that provides parameters to indicate deletion of one or more roaming preparations (or every prior ST preparation). In one case, the roaming parameters element (which may also be referred to as SMD BSS transition parameters element, as provided in the 11bn amendment) is carried in the message 502 to provide roaming related parameters to signal deletion of roaming preparations. A new format may be used for an ST Info field (to carry roaming related parameters) when the roaming parameters element is carried in the message 502 (with specific type value for deleting roaming preparations).

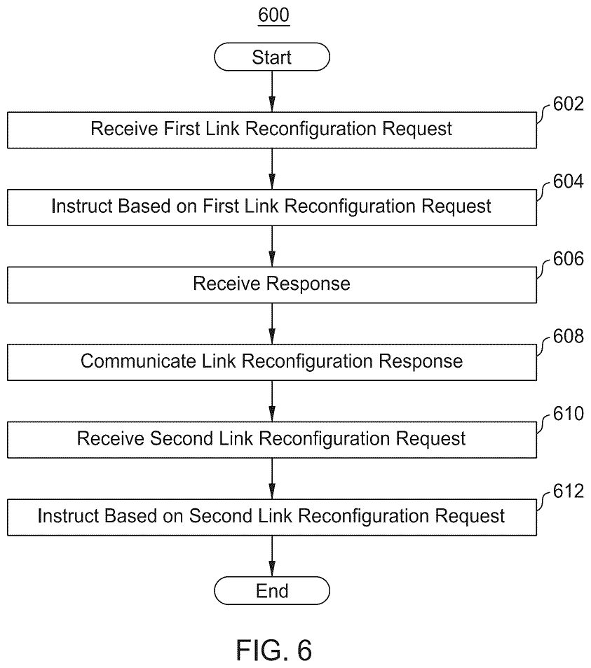

FIG. 6 is a flowchart of an example method 600 performed by the system 100 of FIG. 1A. In certain embodiments, an AP MLD (e.g., the AP MLD 104A shown in FIG. 1A) preforms the method 600. By performing the method 600, the AP MLD deletes roaming preparations.

At 602, the AP MLD receives a first link reconfiguration request from a non-AP MLD. The first link reconfiguration request may indicate that the non-AP MLD is requesting to perform roaming preparation for a target AP MLD.

At 604, the AP MLD instructs the target AP MLD to begin roaming preparation for the non-AP MLD (e.g., in a roaming context transfer request) in response to the first link reconfiguration request. The target AP MLD may then perform roaming preparation. For example, the target AP MLD may add one or more links for the non-AP MLD. At 606, the AP MLD receives a response from the target AP MLD indicating that the roaming preparation is complete. At 608, the AP MLD communicates or transmits a link reconfiguration response to the non-AP MLD to indicate that the roaming preparation at the target AP MLD is complete.

At 610, the AP MLD receives a second link reconfiguration request from the non-AP MLD. The second link reconfiguration request may indicate that the non-AP MLD is deleting the roaming preparation with the target AP MLD. In some embodiments, the AP MLD may receive a link reconfiguration notify frame instead of a second link reconfiguration request.

At 612, the AP MLD instructs the target AP MLD to delete the roaming preparation with the non-AP MLD in response to the second link reconfiguration request. In response, the target AP MLD may delete the roaming preparation. For example, the target AP MLD may remove or delete the links for the non-AP MLD and remove any reserved resources for the non-AP MLD and delete any context of the non-AP MLD.

In some embodiments, the second link reconfiguration request may also request that roaming preparation be performed at another target AP MLD. In response, the AP MLD may instruct the other target AP MLD to perform roaming preparation. The other target AP MLD may then add a link for the non-AP MLD. The other target AP MLD may communicate a response to the AP MLD to indicate that roaming preparation is complete.

In some instances, the second link reconfiguration request may also request that roaming preparation be performed at the target AP MLD, which effectively updates the previous roaming preparation at the target AP MLD. In response, the target AP MLD may delete the previously added links and add new set of links requested for the non-AP MLD.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A first access point multi-link device (AP MLD) comprising:
one or more memories; and
one or more processors communicatively coupled to the one or more memories, the one or more processors configured to, individually or collectively, perform an operation comprising:
receiving, from a non-access point multi-link device (non-AP MLD), a first link reconfiguration request indicating that the non-AP MLD is requesting to perform roaming preparation for a second AP MLD;
instructing the second AP MLD to perform roaming preparation for the non-AP MLD based on the first link reconfiguration request;
transmitting, to the non-AP MLD, a first link reconfiguration response indicating that the second AP MLD is prepared for roaming;
after transmitting the first link reconfiguration response, receiving, from the non-AP MLD, a second link reconfiguration request requesting deletion of the roaming preparation at the second AP MLD; and
instructing the second AP MLD to delete the roaming preparation based on the second link reconfiguration request.

2. The first AP MLD of claim 1, wherein the second link reconfiguration request comprises a reconfiguration multi-link element that includes a reconfiguration operation type value indicating deletion of the roaming preparation.

3. The first AP MLD of claim 1, wherein the second link reconfiguration request comprises a reconfiguration multi-link element that indicates an AP MLD MAC address of the second AP MLD.

4. The first AP MLD of claim 1, wherein the second link reconfiguration request requests deletion of roaming preparations for multiple target AP MLDs in a same SMD as the first AP MLD and the second AP MLD.

5. The first AP MLD of claim 4, wherein the second link reconfiguration request includes multiple reconfiguration multi-link elements to indicate deletion of the roaming preparations for the multiple target AP MLDs, wherein each reconfiguration multi-link element includes a reconfiguration operation type value indicating (i) deletion of roaming preparation and (ii) an MLD MAC address of a target AP MLD at which the roaming preparation is requested to be deleted.

6. The first AP MLD of claim 1, wherein the link reconfiguration request further indicates that the non-AP MLD is requesting to perform roaming preparation to a third AP MLD.

7. The first AP MLD of claim 1, wherein the operation comprises transmitting, to the non-AP MLD, a second link reconfiguration response indicating a status of deletion of the roaming preparation at the second AP MLD.

8. The first AP MLD of claim 7, wherein the second link reconfiguration response indicates that the deletion of the roaming preparation at the second AP MLD is successful.

9. The first AP MLD of claim 7, wherein:
the first link reconfiguration request and the second link reconfiguration request are UHR link reconfiguration request frames; and
the first link reconfiguration response and the second link reconfiguration response are UHR link reconfiguration response frames.

10. The first AP MLD of claim 1, wherein the second link reconfiguration request further indicates that the non-AP MLD is requesting to perform another roaming preparation to the second AP MLD, and wherein the operation comprises:
instructing the second AP MLD to delete a previous roaming preparation for the non-AP MLD and to perform another roaming preparation for the non-AP MLD based on the second link reconfiguration request; and
transmitting, to the non-AP MLD, a link reconfiguration response indicating deletion of the previous roaming preparation at the second AP MLD and a status of the another roaming preparation at the second AP MLD.

11. The first AP MLD of claim 1, wherein the operation comprises, after transmitting the first link reconfiguration response, receiving from the non-AP MLD, a third link reconfiguration request indicating that the non-AP MLD is requesting to perform another roaming preparation to the second AP MLD to update the roaming preparation with the second AP MLD.

12. The first AP MLD of claim 1, wherein the second link reconfiguration request indicates that the non-AP MLD is requesting deletion of every previous roaming preparations between the non-AP MLD and AP MLDs of an SMD of the first AP MLD and the second MLD.

13. A first access point multi-link device (AP MLD) comprising:
one or more memories; and
one or more processors communicatively coupled to the one or more memories, the one or more processors configured to, individually or collectively, perform an operation comprising:
receiving, from a non-access point multi-link device (non-AP MLD), a link reconfiguration request indicating that the non-AP MLD is requesting to roam to a second AP MLD;
instructing the second AP MLD to begin roaming preparation based on the link reconfiguration request;
after receiving the link reconfiguration request, receiving, from the non-AP MLD, a first link reconfiguration notify frame indicating that the roaming preparation at the second AP MLD should be deleted; and
instructing the second AP MLD to delete the roaming preparation based on the first link reconfiguration notify frame.

14. The first AP MLD of claim 13, wherein the first link reconfiguration notify frame indicates that multiple roaming preparations should be deleted.

15. The first AP MLD of claim 13, wherein the operation comprises transmitting, to the non-AP MLD, a second link reconfiguration notify frame indicating a status of deletion of the roaming preparation at the second AP MLD.

16. A method comprising:
receiving, by a first access point multi-link device (AP MLD) and from a non-access point multi-link device (non-AP MLD), a first link reconfiguration request indicating that the non-AP MLD is requesting to perform roaming preparation for a second AP MLD;
instructing, by the first AP MLD, the second AP MLD to perform roaming preparation for the non-AP MLD based on the first link reconfiguration request;
transmitting, by the first AP MLD and to the non-AP MLD, a first link reconfiguration response indicating that the second AP MLD is prepared for roaming;
after transmitting the first link reconfiguration response, receiving, by the first AP MLD and from the non-AP MLD, a second link reconfiguration request requesting deletion of the roaming preparation at the second AP MLD; and
instructing, by the first AP MLD, the second AP MLD to delete the roaming preparation based on the second link reconfiguration request.

17. The method of claim 16, wherein the second link reconfiguration request comprises a reconfiguration multi-link element that includes a reconfiguration operation type value indicating deletion of the roaming preparation.

18. The method of claim 16, wherein the second link reconfiguration request comprises a reconfiguration multi-link element that indicates an AP MLD MAC address of the second AP MLD.

19. The method of claim 16, wherein the second link reconfiguration request requests deletion of roaming preparations for multiple target AP MLDs in a same SMD as the first AP MLD and the second AP MLD.

20. The method of claim 19, wherein the second link reconfiguration request includes multiple reconfiguration multi-link elements to indicate deletion of the roaming preparations for the multiple target AP MLDs, wherein each reconfiguration multi-link element includes a reconfiguration operation type value indicating (i) deletion of roaming preparation and (ii) an MLD MAC address of a target AP MLD at which the roaming preparation is requested to be deleted.
